(19) United States
(12) Patent Application Publication
(10) Pub. No.: US 2023/0244232 A1
(43) Pub. Date: Aug. 3, 2023

(54) PAYLOAD INTERFACE MODULE FOR REMOTELY PILOTED VEHICLES

(71) Applicant: Textron Systems Corporation, Hunt Valley, MD (US)

(72) Inventors: Urbane Dwane Maust, Bel Air, MD (US); Mark Andrew Popowych, Kingsville, MD (US); Christopher David Bevard, Cockeysville, MD (US)

(21) Appl. No.: 18/103,000

(22) Filed: Jan. 30, 2023

Related U.S. Application Data
(60) Provisional application No. 63/304,226, filed on Jan. 28, 2022.

(51) Int. Cl. G05D 1/00

(52) U.S. Cl. CPC G05D 1/0094; G05D 1/0022

(57) ABSTRACT

In a remotely piloted vehicle system, a ground station has a payload controller (PC), ground data terminal (GDT), and first payload interface module (PIM) having a first interface of a payload-specific type to the PC and a first network interface to the GDT, and the first PIM converts between signals of the first interface and corresponding messages of the first network interface. Aa remotely piloted vehicle has a payload (PL), a vehicle data terminal (VDT), and a second PIM having a second interface of the payload-specific type to the PL and a second network interface to the VDT. The VDT is communicatively coupled to the GDT for transfer of messages, and the second PIM converts between messages of the second network interface and corresponding signals of the second interface. The PIMs form respective endpoints of a ground-to-vehicle channel between the PC and PL.

### BACKGROUND

This invention is generally in the field of remotely piloted vehicles (RPVs) such as unmanned aerial systems (UAS), and in particular it relates to remote control of and communications with payloads carried by an RPV.

### SUMMARY

A Payload Interface Module (PEW) is a part of a Universal Payload Architecture (UPA). It provides standard interfaces for certain payloads to be carried by a UAS, such as electro-optical and infrared (EO/IR) sensor payloads for example. In one embodiment, PIM interfaces can include:

1. Power for the payload which is controlled and monitored by the UAS

2. Ethernet

3. Serial ports (e.g., one RS-232, one RS-422)

4. Discrete I/O pins—Each pin is generally monitored as an input and can be individually assigned as an output. Drive voltage for outputs may be programmable.

In the past, payloads such as EO/IR payloads carried by a UAS have been tightly integrated with the UAS, requiring long development times and purpose-built interfaces for each payload. According to UPA, a standard set of interfaces are provided that satisfy the needs of various payload types that are identified as potential candidates to be carried by the UAS.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is an isometric underside view of an unmanned aircraft system (UAS);

FIG. 2 is a functional block diagram of a ground-to-vehicle communications and control system employing payload interface modules (PIMs);

FIG. 3 is a functional block diagram of the system of FIG. 2 highlighting network-related structure and functionality;

FIG. 4 is an isometric view of example housings for a PIM and associated expansion module;

FIG. 5 is a schematic illustration of PIM interfaces;

FIG. 6 is a detailed schematic diagram of a PIM according to one embodiment;

FIG. 7 is a detailed schematic diagram of an expansion module according to one embodiment;

FIG. 8 is a block diagram of general-purpose input/output (GPIO) aspects of a PIM according to one embodiment;

FIG. 9 is a block diagram illustrating a software organization of a PIM according to one embodiment.

FIG. 10 is a schematic illustration of scalability using a PIM and associated expansion modules;

FIGS. 11-13 are schematic illustrations of different communication models that may be supported in various embodiments.

### DETAILED DESCRIPTION

### Overview

A payload interface module (PIM, also referred to as “payload interface box” or PIB) as disclosed herein can provide an interface to variety of payloads, including for example an EO/IR payload, communications radios, radar (e.g., synthetic aperture radar for mapping), electronic warfare (EW) gear, and weapons. A PIM onboard a UAS is paired with a corresponding PIM on the ground, enabling customized remoting of control functionality.

In one embodiment, the PIM is architected with a DSP microcontroller (DSP) providing low level processing to manage direct communication with hardware elements that provide interfaces between the UAS system and a corresponding payload and its controller. A power switch (e.g., high-side switch) controls power to the payload, with the DSP making measurements of voltage and current. Power can be commanded off by the DSP if an overcurrent condition is detected. The DSP also controls and virtualizes communications with the payload through the serial ports and discrete I/O pins. These virtualized communications occur between a vehicle-borne PIM and a paired PIM in a ground station, making them available to the native payload controller for that payload. The UAS system may utilize a routed ethernet interface between the air and ground segments. The paired air and ground PIN/Is create an infrastructure that simplifies the implementation of payloads using ethernet, by making an ethernet port at the payload appear as if it is on the same subnet as an ethernet port at the payload controller on the ground, which is done using an ethernet internet protocol (IP) tunnel through that routed network. Bandwidth usage of the ethernet connection between the payload and its controller may be monitored and can be throttled if necessary.

The PIM architecture has also been designed to be expandable. Power and data interfaces needed to add more, or different types of payload interface channels are designed in allowing for additional flexible for future capabilities.

Prior UAS systems have sought to solve the problem of long integration times for new payloads. In one example, a set of interfaces have been predefined that would generically be available for new payload types. A PIM implementation within UPA as disclosed herein places a microprocessor running an operating system on top of a hardware architecture having generic interfaces. This allows the PIM to handle more complex network environments by leveraging interface support available in the operating system. The PIM architecture also supports the concept of providing not only an interface to the payload but also a designed in endpoint with the complement of that interface on the ground for a connection to the payload's native controller through the pairing of air and ground PIMs.

Thus, the following objectives are addressed by the disclosed improvements, generally directed to a distributed universal payload architecture in a remotely piloted vehicle such as an autonomous aircraft:

1. Enables expansion of aircraft capabilities, beyond specialized reconnaissance & communication relay, creating a universal utility vehicle.

2. Enables rapid integration of new payloads in response to real-time emerging threats.

3. Enables rapid interchange of payloads in the field in response to varying mission sets.

### Embodiments

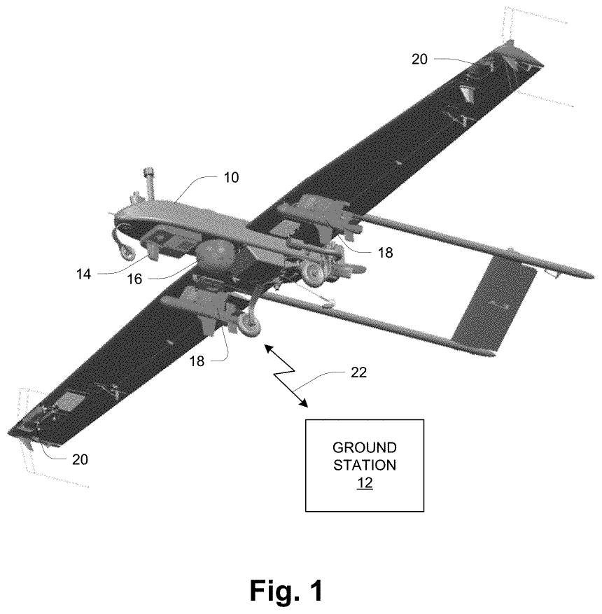

FIG. 1 shows a remotely piloted vehicle, namely an unmanned aircraft or “drone” 10, carrying various payloads that are used during operation, along with a ground station 12 that is in communication with the vehicle 10 to provide command-and-control (C2) functionality, both for general flight control as well as remotely controlled use of the payloads. In this example, payload areas of the vehicle 10 include a chin pod payload bay 14, a main payload bay 16, two center-wing bays 18, and two outer wing bays 20. As described more below, at each location there are one or more functional devices, generally referred to as “payloads”, such as sensors (e.g., electro-optical (EO) or infrared (IR)), communications radios, radar (e.g., synthetic aperture radar for mapping), electronic warfare (EW) gear, weapons, etc. Both the vehicle 10 and ground station 12 employ specialized modules called “payload interface modules” (PIMs) to provide multi-layer interfacing of payload-specific components (controller, payload itself) to a ground-to-vehicle link 22 and distributed network structure for remote C2 functionality accordingly, as described in greater detail herein.

The following are general features of the payload C2 system employing distributed PIMs as described herein:
Electrical Power: Discretely Controllable Electrical Power To Various Payload Bays
Communications—Payload C2 & Data Transmission Within Air Vehicle And Between Air & Ground
Ground Control—Payload C2 & Data Transmission On The Ground

In this description, the more general term “vehicle” is used to refer to a remotely piloted vehicle, such as a UAS 10, employing a PIM-based payload architecture as described herein. The disclosed techniques have more general applicability to other types of remotely piloted vehicles including for example water-borne or land-borne vehicles.

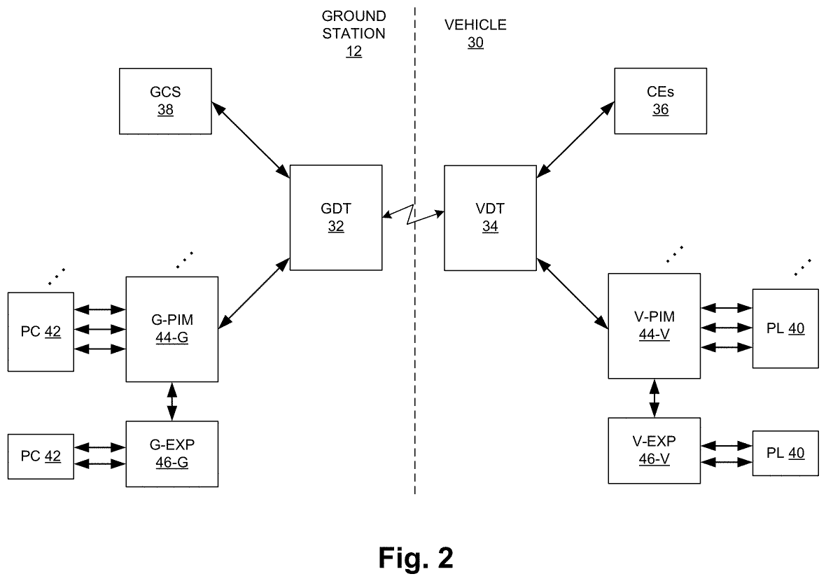

FIG. 2 is a functional block diagram of the overall system, showing components of the ground station 12 as well as the remotely piloted vehicle 30 (e.g., UAS 10). Ground-to-vehicle communication (e.g., radio communication) is provided by a ground data terminal (GDT) 32 and vehicle data terminal (VDT) 34. The vehicle 30 generally includes various controlled elements (CEs) 36 such as flight control elements, position and environment sensors, etc., for which a ground control subsystem (GCS) 38 provides C2 functionality. The payload subsystem includes vehicle-borne payloads (PLs) 40 and associated ground-based payload controllers (PCs) 42 (plurality indicated by ellipses). These are interfaced to the associated data terminal 34, 32 by respective PIMs shown as vehicle PIMs (V-PIM) 44-V and ground PIMs (G-PIM) 44-G, which as described below may have a common overall design and implementation and be customized to the respective ground/vehicle environment by configuration. In some embodiments the system may employ expansion modules V-EXP 46 (46-V, 46-G) to provide for local expansion to additional payloads 40 and controllers 42.

In this description, a local PL 40 or PC 42 connected to a PIM 44 or expansion module 46 is also referred to more generally as a “payload element”, reflecting the use of a common-design PIM at either the ground or vehicle end in a system. It will be understood that in this use, “payload element” refers to either a PL or a PC to which the PIM is connected.

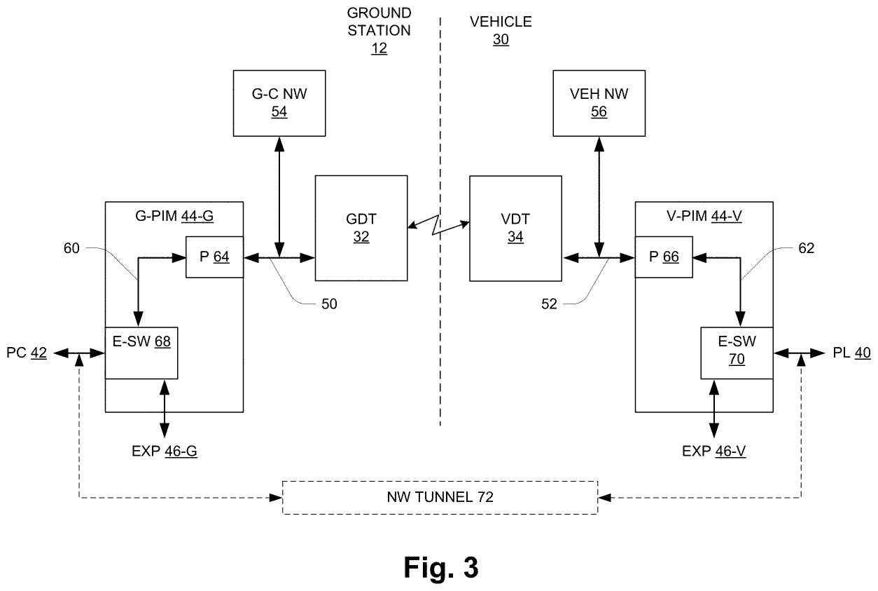

FIG. 3 illustrates certain network- and communication-related aspects of the system. The ground system 12 employs a ground system network 50 while the vehicle 30 employs a vehicle network 52, both of which may be realized for example as TCP/IP networks on underlying connection hardware such as Ethernet® etc. The ground network 50 is connected to one or more PIMs 44-G and functionally separate ground-control network (G-C NW) elements 54, and similarly the vehicle network 52 is connected to one or more PIMs 44-V and functionally separate vehicle network (VEH NW) elements 56. Each PIM 44 includes a respective internal network 60, 62, a respective port (P) 64, 66 connected to the respective network 50, 52, and a respective Ethernet switch (E-SW) 68, 70 providing connections to an associated PL 40 or PC 42 as well as to any local expansion module 46 if present. As described herein, the PIM-related structure and functionality provide a virtualized end-to-end connection between payload 40 and controller 42, indicated in FIG. 3 as a network tunnel 72.

The following are general features that may be realized by or using a PIM 44 as disclosed herein:

1. The PIM design creates an end-to-end duplication of each of the interfaces present at a payload 40 on a paired PIM 44 at a corresponding payload controller 42, allowing for a non-integrated payload to be operated by its payload controller without additional configuration or software within the unmanned system. Previous solutions have required specific and expensive system integration to make those interfaces available to a payload controller.

2. The PIM design includes computing hardware capable of supporting an Operating System (e.g., Linux, Windows).
Leverages software support available natively from the Operating System
Enables the support of additional types of interfaces that are not suitable for remote use via signal virtualization (e.g., USB)

3. The PIM can be designed with an expansion port, allowing additional (e.g., up to 2 or 4) payload interfaces to be added without the need to duplicate the processor portion of the PIM. Additional types of interfaces can be implemented in each expansion payload interface. Payload power is provided for each additional interface. The PIM software is designed to handle the complexity of pairing payload and payload controller PIMs when the use of expansion interfaces is introduced.

4. The PIM ethernet network is built using a processor containing two ports to allow separation between the payload network and remaining vehicle network components 56. This means that network routing within the remote vehicle network 52 only needs to be established when the PIMs are implemented into the system. When payloads are introduced the payload network is independent from the vehicle and ground control networks 52, 50. The payload networks can be realized to appear as if they are on the same subnet using an IP tunnel established between the PIMs through the vehicle and ground control networks.

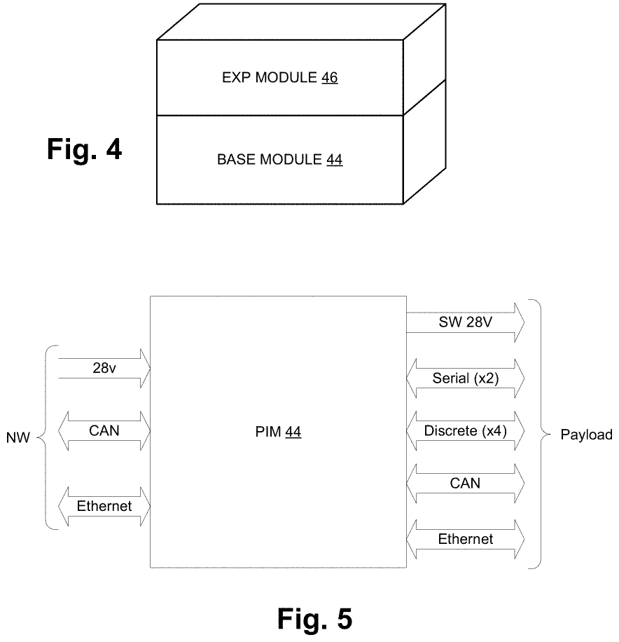

FIG. 4 is a simplified view of an overall mechanical implementation having both the PIM (base module) 44 and expansion module 46 in stackable box-shaped housings. In one embodiment, the housings have a length/width footprint of 4″ by 3″, and heights in the range of 1 to 2 inches.

FIG. 5 illustrates external interfaces of a PIM 44, shown as network-side (NW), for connection to the ground network 50 or vehicle network 52 location, and payload-side, for connection to a payload 40 or payload controller 42. In the illustrated embodiment, the NW-side connections include a power connection to a 28-volt bus (28V), a CANBUS connection (CAN, controller area network), and an Ethernet connection. The payload-side connections include a switch power connection (Switched 28V), 2 serial buses, 4 discrete I/O connections, a CANBUS connection and an Ethernet connection.

As described in more detail below, in one embodiment these may be the overall capabilities of a base module 44 and expansion module 46:

Base Module
Processor and interface to AV
Interface to single Payload
Interface addressing and virtualization.
Activity monitoring and logging

Expansion Module(s)
Interface to 2nd Payload in AV
Interface to Control Stations on ground.
Expandable to additional Payloads
Future addition of interface types

The following are additional hardware/electrical aspects in various embodiments:

I. Network interface module for control of a payload or payloads
Scalable with one processor able to control levels of I/O
Designed to handle distributed or concentric networking
Low size, weight, power
Supports quick turn development

II. Example hardware specifics:
Interfaces to include a base set: 10/100 Ethernet
Serial: (1) CAN Bus 2.0, (1) RS-232, (1) RS-422
One controllable power channel with programmable trip and UV monitoring
Processing to allow an OS
Mil-STD-704 power (28 VDC)
Mil-STD-461E (CE101/2, RE101/2, RS101/3)
Mil-STD-810F (assorted)
D Connectors for initial application (other options also being explored)

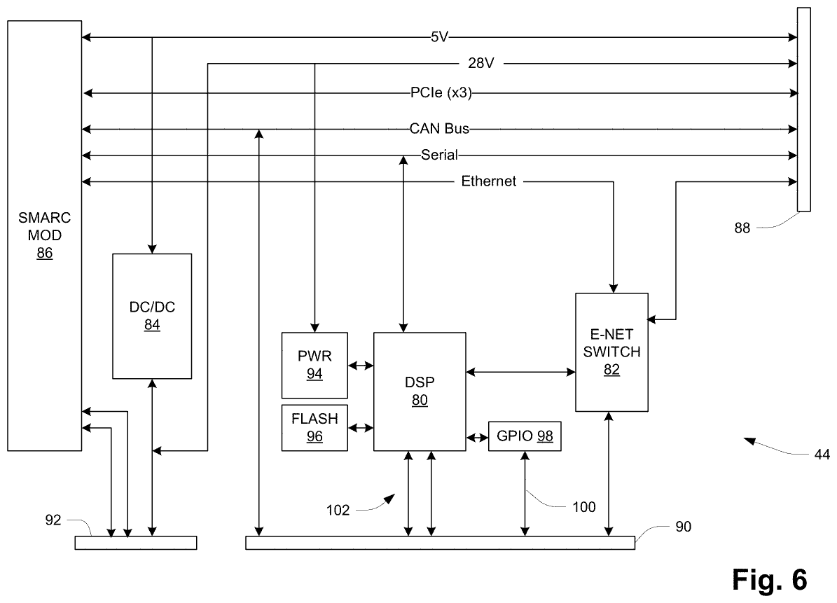

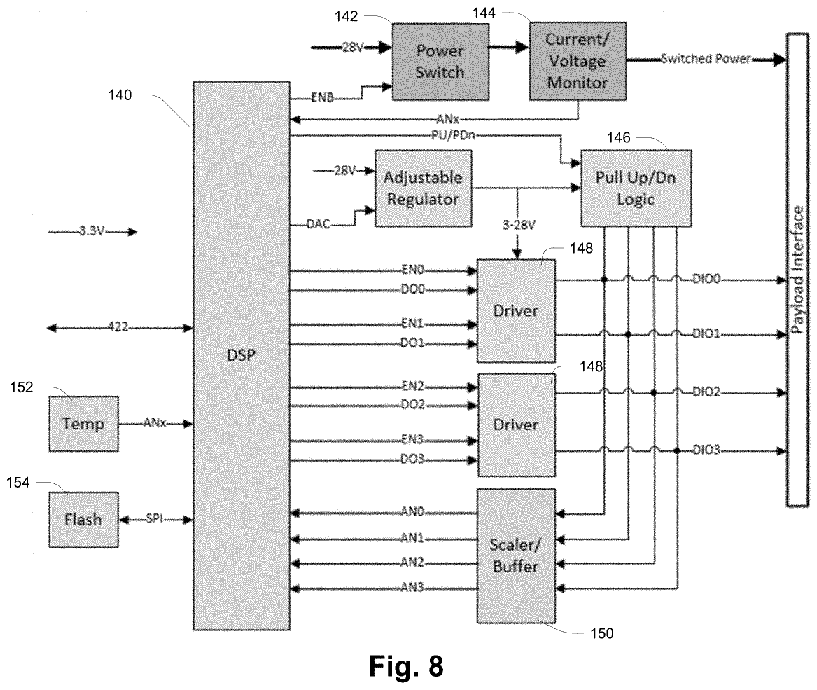

FIG. 6 is a schematic diagram of a base PIM 44 according to one embodiment. It includes a digital signal processor (DSP) 80, Ethernet (E-NET) switch 82, DC-DC converter 84 and a daughter module shown as a “Smart Mobility Card” (SMARC) module 86. It also includes a set of connectors for external connections including an expansion connector 88, a payload connector 90, and an avionics connector 92. Associated with the DSP 80 are power circuitry (PWR) 94, Flash memory 96, and general-purpose I/O (GPIO) circuitry 98, which is described in some detail below with reference to FIG. 8. The PIM 44 carries and terminates a variety of signals including a 5-volt bus 5V, a 28-volt bus 28V, three PCI-Express (PCIe) buses, a CAN bus, one or more serial buses, and four Ethernet buses all terminated at the Ethernet switch 82. DSP-associated signals further include Data signals 100 and additional serial bus signals 102.

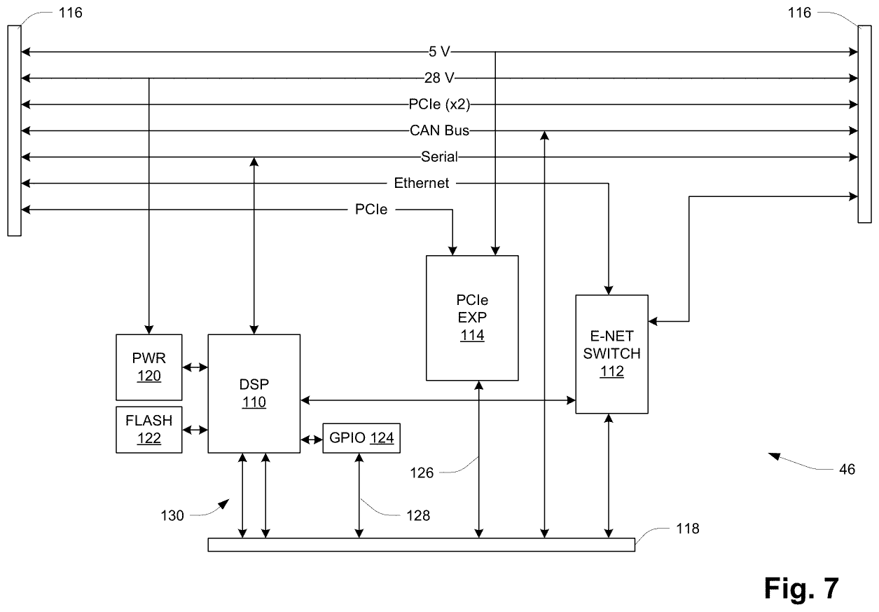

FIG. 7 is a schematic diagram of an expansion module 46 according to one embodiment. It includes a digital signal processor (DSP) 110, Ethernet (E-NET) switch 112, and a PCI expansion (EXP) module 114. It also includes a set of connectors for external connections including two expansion connectors 116 and a payload connector 118. Associated with the DSP 110 are power circuitry (PWR) 120, Flash memory 122, and general-purpose I/O (GPIO) circuitry 124, which is described in some detail below with reference to FIG. 8. The expansion module 46 carries and terminates a variety of signals including a 5-volt bus 5V, a 28-volt bus 28V, three PCI-Express (PCIe) buses, a CAN bus, one or more serial buses, and four Ethernet buses all terminated at the Ethernet switch 112. Additional signals include function signals 126, Data signals 128, and additional serial bus signals 130.

Below are circuitry/features that may be included in an expansion module 46 in various embodiments:
High-power switch(es) using suitable connector arrangements.
Coaxial/RF/Signal switches or multiplexers
Pulse/frequency counters
Programmable resistance/loads
Signal conditioners for accelerometers, strain gauges, pressure, or temperature sensors
Memory modules (flash ram, SD slots)
PWM drivers for servo control
Current loop outputs/sensors
Specialty Interfaces
Pattern Generators

FIG. 8 is a block diagram showing general-purpose I/O (GPIO) architecture features of a PIM 44. A local DSP 140 controls functionality. A power switch 142 with current and voltage monitoring 144 are included, with programmable trip characteristics. There are also four discrete IO channels DI00-DI03 (may be expandable) for which the drive level may be programmable (LVTTL thru supply level). Drivers 146 use totem pole output, driven directly by DSP 140. Pull-ups/downs 148 are used and may be enabled per channel. Direct analog measurements ANO0-ANO3 of outputs via scaler/buffer 150. Also included are onboard temperature measurement (TEMP) 152 and Flash memory 154 for logging.

The power switch 142 and monitoring circuitry 144 may feature the following:
High Side Switch
Voltage and Current Monitoring
Overload Protection (current limit, short circuit)
   Overvoltage protection
Thermal shutdown with restart
Diagnostic Feedback

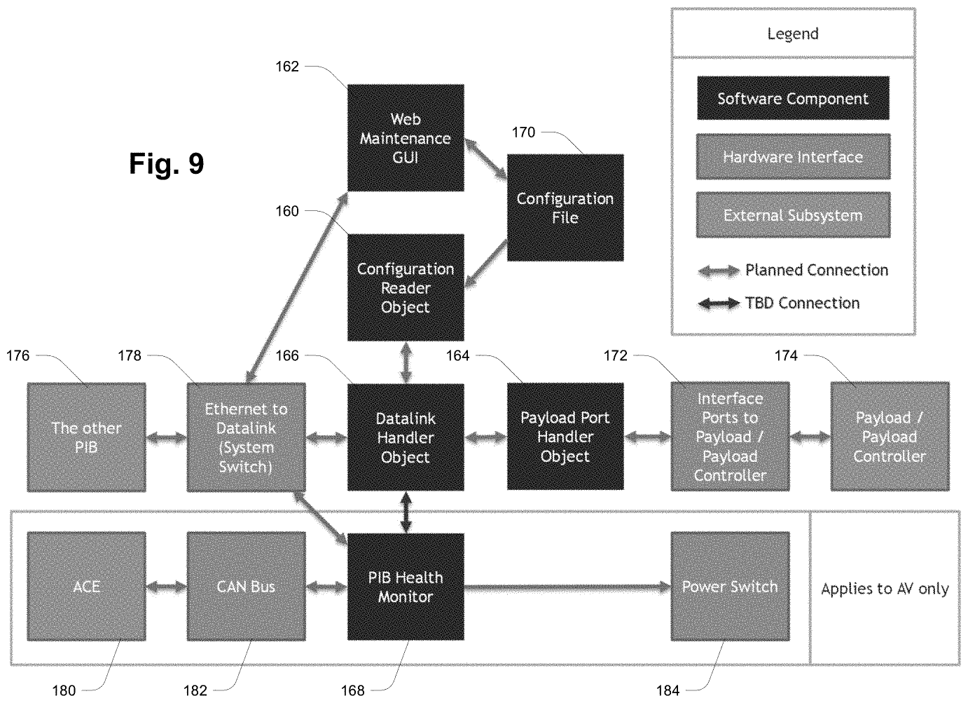

FIG. 9 is a block diagram of key software-implemented elements and their relation to other system elements. The following are high-level objectives and characteristics of the software system:
Focus on abstracting and generalizing the controller to payload connection.
Each PIM 44 supports a set of interfaces connected to either a Payload 40 or a Payload Controller 42.
   PIM software scales with hardware.
Each PIM 44 converts payload/controller messages to user datagram protocol (UDP) which are transmitted to complementary PIM 44 which converts the message back.
   Primary Datalink signal.
   PIM datalink communication is bi-directional.
   PIMs depend on software configuration via a configuration file.
   Each PIM is configured with a unique static IP address.
   By default, configuration identifies the complementary (far-end) PIM.
   PIM is interchangeable—a PIM unit can be configured for use in either the ground station 12 or vehicle 30.
PIM software monitors and reports network bandwidth usage and recommend action on excess use.
PIM software monitors and controls power to the payload and report HW health.

A PIM 44 runs an operating system, such as Ubuntu Linux for example, and application-level components including the following;
Configuration Reader Object 160—Parse configuration file 170 and initialize the rest of the application and OS settings on start up.
Configuration Maintenance Web GUI 162—Provides an interface to view and modify the configuration file 170 over a web browser. Payload Port Handler Object 164—Identifies, opens, listens, and sends on all the payload ports. Messages received on payload ports are handed over to the Datalink Handler Object. Messages received from the Datalink Handler Object 166 have the header removed and are sent out the appropriate payload port via port interface 172 and controller 174.
Datalink Handler Object 166—Prepends a header to the message and sends out the Ethernet port to the complementary PIM 176 over the Primary Datalink 178 as a UDP packet according to configured communication scheme. Receives messages from the complementary PIM 176 and hands them over to the Payload Port Handler Object 164. Monitors the network traffic—how many payload message packets go out and come in and reports bandwidth usage statistics to the ground station 12.
   The prepended header contains info for the complementary PIM 176 including a spooler and which interface port the message should be sent out.
PIM Health Monitor 168 (Vehicle Only)—Monitors temperature, power usage, any other sensors, writes log files, listens for payload power commands from the ACE 180 over the CAN bus 182. The vehicle 30 receives power commands over S200 from a ground VSM GUI and provides control to a local power switch 184.
PIM application software may be written using C++. Application GUIs, such as the power control dialog, can be written for the DVSM using C++and the Qt framework. Configuration file 170 can use XML, and the web configuration GUI 162 can use HTML.

Hardware Abstraction:
Each PIM 44 supports a set of interface ports 172 connected to either the local Payload or Payload Controller.
The PIM software listens to these ports for data.
Any data received is converted to UDP Ethernet packets which are sent to the complementary PIM 176. Bi-directional Communication is used.
The complementary PIM 176 converts the data back and sends it out over the local same-type interface port that the data was received on.

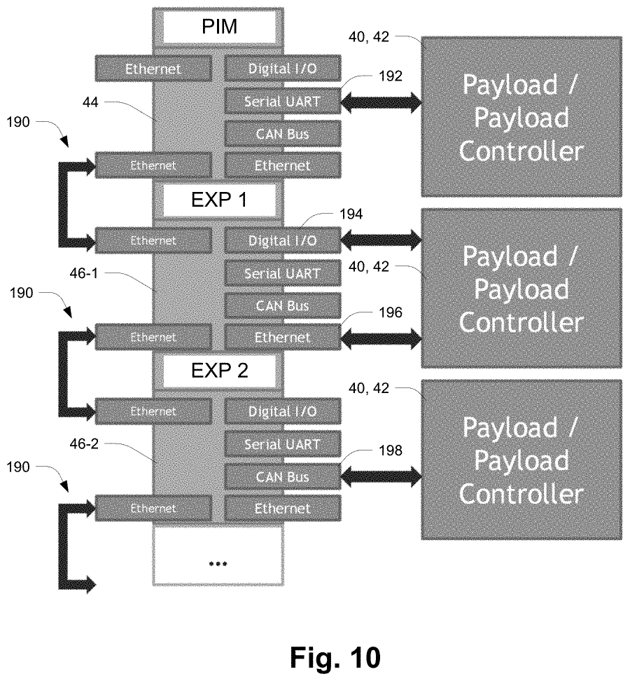

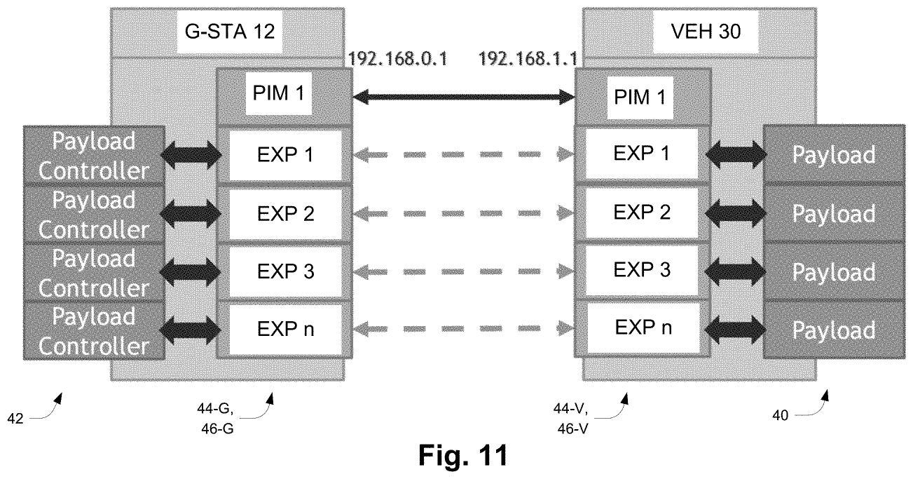

FIG. 10 illustrates scalability using expansion modules 46 connected in daisy-chain fashion to a PIM 44 to provide connection to multiple local payloads 40 or payload controllers 42. Adjacent modules are connected by respective Ethernet connections 190 for this purpose. In this example, the single PIM 44 interfaces to a local PL 40 or PC 42 via a serial transceiver

(UART) 192. A first expansion module 46-1 interfaces to a local PL 40 or PC 42 via a digital I/O port 194 and Ethernet port 196. A second expansion module 46-2 interfaces to a local PL 40 or PC 42 via a CAN Bus 198.

The PIM software scales with hardware I/O expansions. The OS detects I/O ports from expansions. In some embodiments, it may be preferable to increase the number of interface ports on one PIM rather than increase the number of PIMs 44 or expansion modules 46 in the system. A single larger PIM may be easier to manage but would generally consume more physical volume and thus may present placement issues, in which case an approach of using multiple smaller PIMs 44 and/or expansion modules 46 may be preferred.

FIGS. 11-13 illustrate PIM-PIM communications according to different configurations which may be suitable for different types of deployments. Generally, each PIM 44 is logically mapped to a complementary PIM 44 on the opposite subsystem.

FIG. 11 illustrates one-to-one communication between a PAIR of PIMs 44 using expansion modules 46. Interface ports and sub-slots are logically mapped between corresponding PIMs 44-G, 44-V of the ground station (G-STA) 12 and vehicle (VEH) 30, i.e., data received on sub-slot 2 on a ground PIM 44-G is directed to sub-slot 2 on the corresponding vehicle PIM 44-V.

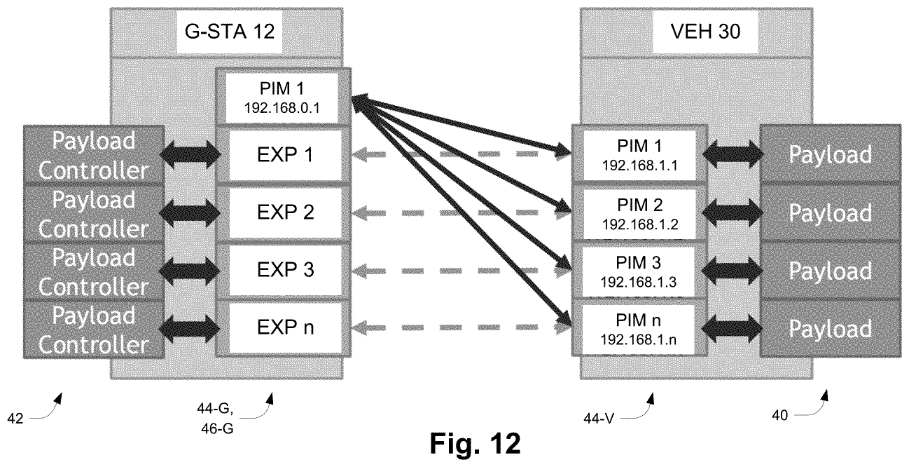

FIG. 12 illustrates one-to-many communication, using one PIM 44-G and expansion modules 46-G on the ground side and a set of PIMS 44-V on the vehicle side. Each slot, or PIM 44-V, on the vehicle 30 maps to one slot, or the single PIM 44-G, at the ground station 12, while each sub-slot on the ground PIM 44-G maps to each slot on the vehicle 30. The ground PIM 44G knows how many vehicle PIMs 44-V it must talk to based on its sub-slot count.

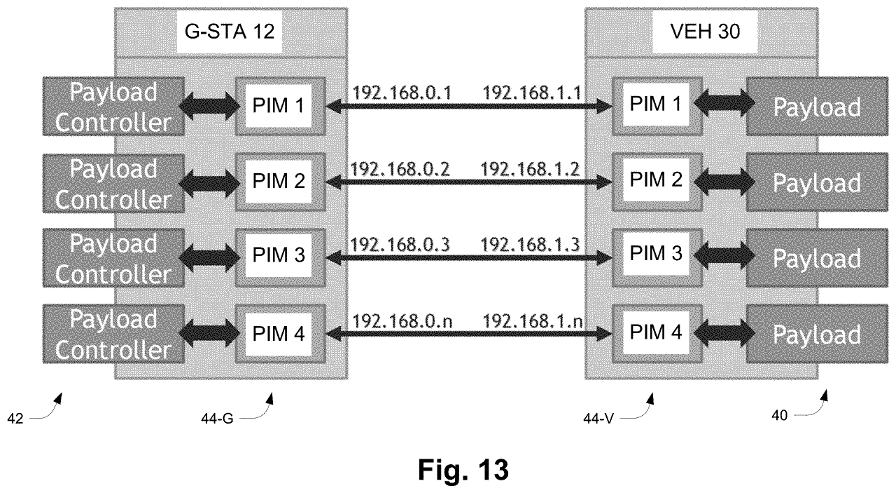

FIG. 13 illustrates many-to-many communication. A system can support multiple pairs of PIMs 44-V, 44-G to support multiple payloads simultaneously. Therefore, each PIM 44 is mapped to a single complementary PIM 44 on the opposite subsystem via configuration.

The following are additional specific aspects of functionality that may be realized in some embodiments:

1. PIM Detection
PIM may know who to talk to by software configuration.
Possible hardware solutions for putting PIM in known initial and accessible state:
   Wire harness modification to provide each PIM with a default configuration based on connection.
   Physical externally accessible multi-position switch to set a PIM ID prior to installation.
Alternative software possibilities
   Put PIMs into maintenance state via message over CAN from the ACE
   DHCP server on the vehicle, port-based address allocation. Assign one specific address per port.

2. Software Configuration
Every PIM is configured with a slot and communication scheme.
   Slot—a logical slot doubling as an identifier.
      Provides the MI's static IP address.
      One PIM per slot
   Communication scheme—makes PIMs aware of how they are organized.
      Provides the complementary PIM's IP address.
      PIM assumes the complementary PIM is present and alive.
   Preset communication schemes:
      One-to-one (FIG. 11)—One big PIM on the GCS maps to one big PIM on the AV
      One-to-many (FIG. 12)—One big PIM on the GCS maps to multiple little PIMs on the AV and multiple little PIMs on the AV map to one big PIM on the GCS. Every Little PIM knows the slot of the Big PIM, which must be known (e.g., slot 1).
      Many-to-many (FIG. 13)—Multiple little PIMs on the GCS each map to one of multiple little PIMs on the AV.
      Other schemes (e.g., multiple Big PIIVls or a mix of Big and Little PIIVls) may also be used.

3. Communication Configuration
Slots—Each PIM configured with a logical slot number which doubles as an identifier.
   Reserved pre-defined static IP address for each slot.
   Loosely correspond to physical location. Documentation maps logical slot to physical location.
      Example: Slot 2=left center wing and Slot 3=right center wing for a particular AV payload layout.
   Each PIM can only occupy one slot. Two PIN/Is in the same slot causes an IP conflict.
sub-slot—A set of I/O ports within a slot. PIM SW determines this automatically based on number of I/O
   The base board of every PIM has one set of I/O ports, so each PIM has at least one sub-slot.
   Each expansion adds a new set of I/O ports, and a new sub-slot.
Port—One individual payload interface port within a sub-slot. From the OS perspective, each port has number used for sub-slot association (e.g., eth0, eth1, eth2=sub-slot 0, 1, 2 respectively)
For now, slots, sub-slots, and ports map by ID. That is, the PIM in slot 1 on the GCS communicates with the PIM in slot 1 on the AV and vice versa IAW pre-defined communication schemes. This can be changed by alternative custom communication rules.

4. Other Configuration
System Host (ground station 12 or vehicle 30)
Payload interface port specific configuration
   Override port identification, each port is identified by its sub-slot and type (e.g., sub-slot 2, Serial)
   Ethernet—IP override, Port number override, UDP/TCP flag
   Serial—Baud rate, Parity, Start Bit, Stop Bit, Flow Control, List of Sync Bytes, Length of Packet
   Custom Communication Rules (e.g., user-created or user-centric)
   Future rulesets for specifically defining where messages should go, from slot/sub-slot/port to slot/sub-slot/port and under which conditions.
May provide rules for specific payload messages based on message bytes.
   (e.g., A payload message beginning with OxAA, OxBB, OxCC is critical and receipt should be acknowledged by the complementary PIM, else retry some number of times)

Web Configuration GUI
Each PIM features a configuration GUI 162 which is accessible via web browser and known HTTPS port (e.g., 443).
A configuration application may be used in the ground station 12 which queries all the PIMs across the entire system (vehicle 30 must be on with link) for their configuration which is displayed altogether on one interface for quick and easy multi-PIM configuration and verification.
   Automatically queries every possible PIM IP address.
   May also be ran from a maintenance laptop (i.e., connected to the SMC maintenance port)
   The central PIM configuration utility can use SFTP to copy each PIM's configuration file to a central location, read and apply modifications and then SFTP the file back to the PIM to apply configuration changes.

While various embodiments of the invention have been particularly shown and described, it will be understood by those skilled in the art that various changes in form and details may be made therein without departing from the scope of the invention as defined by the appended claims.

What is claimed is:

1. A remotely piloted vehicle system, comprising:
a ground station having a payload controller, a ground data terminal, and a first payload interface module, the first payload interface module having a first interface of a payload-specific type to the payload controller and a first network interface to the ground data terminal, the first payload interface module being configured and operative to convert between signals of the first interface and corresponding messages of the first network interface; and
a remotely piloted vehicle having a payload, a vehicle data terminal, and a second payload interface module, the second payload interface module having a second interface of the payload-specific type to the payload and a second network interface to the vehicle data terminal of the vehicle, the vehicle data terminal being communicatively coupled to the ground data terminal for transfer of messages therebetween, the second payload interface module being configured and operative to convert between messages of the second network interface and corresponding signals of the second interface,
the payload interface modules forming respective endpoints of a ground-to-vehicle channel between the payload controller and the payload.

2. The remotely piloted vehicle system of claim 1, wherein each of the first and second interfaces is one of plurality of interfaces of distinct payload-specific types of the respective payload interface modules.

3. The remotely piloted vehicle system of claim 2, wherein the payload-specific types of the plurality of interfaces are serial bus, discrete digital I/O signal, and a second network interface.

4. The remotely piloted vehicle system of claim 1, wherein each of the payload interface modules further includes power circuitry and payload-side connections, the payload-side connections of the second payload interface being connected to the payload to provide switched power thereto.

5. The remotely piloted vehicle system of claim 1, wherein the ground station employs a ground network and the vehicle employs a vehicle network, the ground network being connected to the second payload interface module and to functionally separate ground-control network elements, the vehicle network being connected to the first payload interface module and to functionally separate vehicle network elements.

6. The remotely piloted vehicle of claim 5, wherein each of the payload interface modules includes a respective internal network, a respective port connected to the respective ground or vehicle network, and a respective Ethernet switch providing switched connections including to the respective payload or payload controller.

7. The remotely piloted vehicle system of claim 1, wherein the ground station and remotely piloted vehicle each contain a respective expansion module coupled to the respective payload interface module, each expansion module configured to provide an interface to a respective payload or payload controller respectively and form an endpoint of a second ground-to-vehicle channel between a second payload controller of the ground station and a second payload of the vehicle.

8. The remotely piloted vehicle system of claim 1, wherein each of the payload interface modules is housed in a respective housing for modular placement in proximity to the respective, separately housed, payload or payload controller.

9. The remotely piloted vehicle system of claim 1, wherein the payload interface modules are configurable for distinct communications models including one-to-one, one-to-many, and many-to-many, the one-to-one model being characterized by logical mapping of interface ports and sub-slots of corresponding payload interface modules of the ground station and vehicle in which data received on a given sub-slot of the first payload interface module is directed to a corresponding sub-slot of the second payload interface module.

10. The remotely piloted vehicle system of claim 9, wherein the one-to-many model is characterized by logical mapping of a plurality of payload interface modules of the vehicle to corresponding expansion modules connected to a single payload interface module of the ground station.

11. The remotely piloted vehicle system of claim 9, wherein the many-to-many model is characterized by mapping of each of a plurality of payload interface modules of the ground station to corresponding ones of a plurality of payload interface modules of the vehicle.

12. A payload interface module for use in a remotely piloted vehicle system, comprising a processor, network circuitry, and external connectors for connection to a local data terminal and to a local payload element of a payload-specific type, the connection to the local data terminal providing for transfer of messages to the payload interface module from a paired opposite-end payload interface module via the data terminal, the payload interface module being configured and operative to convert between the messages corresponding signals of the connection to the local payload element, the payload interface modules forming respective endpoints of a ground-to-vehicle channel between the local payload element and a remote payload element connected to the opposite-end payload interface module.

13. The payload interface module of claim 12, wherein the connection to the local payload element includes first and second interfaces each being one of a plurality of interfaces of distinct payload-specific types.

14. The payload interface module of claim 13, wherein the payload-specific types of the plurality of interfaces are serial bus, discrete digital I/O signal, and a second network interface.

15. The payload interface module of claim 12, wherein the payload interface module further includes power circuitry and payload-side power connections for connection to the payload element to provide switched power thereto.

16. The payload interface module of claim 12, wherein the network circuitry includes an internal network, a network port carried by one of the external connectors, and a network switch providing switched connections including to the payload element.

17. The payload interface module of claim 12, wherein the external connectors include an expansion connector for connection to an expansion module, the expansion module being configurable to provide an interface to a respective second payload element and form an endpoint of a second ground-to-vehicle channel between the second payload element and a second remote payload element.

18. The payload interface module of claim 12, housed in a housing for modular placement in proximity to the separately housed payload element.

19. The payload interface module of claim 12, configurable for distinct communications models including one-to-one, one-to-many, and many-to-many, the one-to-one model being characterized by logical mapping of interface ports and sub-slots of corresponding payload interface modules of a ground station and a vehicle in which data received on a given sub-slot of the first payload interface module is directed to a corresponding sub-slot of the second payload interface module.

20. The payload interface module of claim 19, wherein the many-to-many model is characterized by mapping of each of a plurality of payload interface modules of the ground station to corresponding ones of a plurality of payload interface modules of the vehicle.
